(19) United States
(12) Patent Application Publication
(10) Pub. No.: US 2010/0056249 A1
(43) Pub. Date: Mar. 4, 2010

(54) GAMING MACHINE FOR VARYING NUMBER OF TRIGGER SYMBOLS AND CONTROL METHOD THEREOF

(75) Inventor: Hiromoto Yamauchi, Koto-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Aruze Corp., Koto-Ku (JP)

(21) Appl. No.: 12/510,936

(22) Filed: Jul. 28, 2009

Related U.S. Application Data
(60) Provisional application No. 61/094,083, filed on Sep. 4, 2008.

(51) Int. Cl. A63F 9/24; A63F 13/00

(52) U.S. Cl. 463/20; 463/30

(57) ABSTRACT

In a slot machine, a unit game in which symbols having been arranged are rearranged is displayed on a display. Then, a special game is displayed on the display in case where a predetermined condition has been met. In addition, in the slot machine, rearranged specific symbols are counted before a special free game and it is determined to increase the number of trigger symbols in the special free game according to the number of counted specific symbols. Since an award provided to a player is varied according to the number of trigger symbols rearranged in the special free game, a player's sense of expectancy can be focused on the special free game.

### CROSS-REFERENCE TO RELATED APPLICATION

This application is based upon and claims the benefit of U.S. Provisional Patent Application Ser. No. 61/094,083, filed on Sep. 4, 2008; the entire contents of which are incorporated herein by reference for all purposes.

### BACKGROUND OF THE INVENTION

1. Field of the Invention

The present invention relates to a slot machine for playing games using medals and so on, and a control method of a slot machine.

2. Description of Related Art

A player can play a game provided at a slot machine by betting a wager amount such as coins and credits in a facility in which slot machines are installed, as described in U.S. Pat. No. 5,820,459, U.S. Pat. No. 6,695,697, United States Patent Application Laid-Open No. 2003/0069073, European Patent Application Laid-Open No. 1192975, U.S. Pat. No. 6,254,483, U.S. Pat. No. 5,611,730, U.S. Pat. No. 5,639,088, U.S. Pat. No. 6,257,981, U.S. Pat. No. 6,234,896, U.S. Pat. No. 6,001,016, U.S. Pat. No. 6,273,820, U.S. Pat. No. 6,224,482, U.S. Pat. No. 4,669,731, U.S. Pat. No. 6,244,957, U.S. Pat. No. 5,910,048, U.S. Pat. No. 5,695,402, U.S. Pat. No. 6,003,013, U.S. Pat. No. 4,283,709, European Patent Application Laid-Open No. 0631798, German Patent Application Laid-Open No. 4137010, United Kingdom Patent Application Laid-Open No. 2326830, German Patent Application Laid-Open No. 3712841, U.S. Pat. No. 4,964,638, U.S. Pat. No. 6,089,980, U.S. Pat. No. 5,280,909, U.S. Pat. No. 5,702,303, U.S. Pat. No. 6,270,409, U.S. Pat. No. 5,770,533, U.S. Pat. No. 5,836,817, U.S. Pat. No. 6,932,704, U.S. Pat. No. 6,932,707, U.S. Pat. No. 4,837,728, European Patent Application Laid-Open No. 1302914, U.S. Pat. No. 4,624,459, U.S. Pat. No. 5,564,700, International Patent Application Laid-Open No. 03/083795, German Patent Application Laid-Open No. 3242890, European Patent Application Laid-Open No. 0840264, German Patent Application Laid-Open No. 10049444, International Patent Application Laid-Open No. 04/095383, European Patent Application Laid-Open No. 1544811, U.S. Pat. No. 5,890,963, European Patent Application Laid-Open No. 1477947, European Patent Application Laid-Open No. 1351180, U.S. Pat. No. 6,461,241, United States Patent Application Publication No. 2003/0216165, United States Patent Application Publication No. 2004/0033827, United States Patent Application Publication No. 2004/0053676 and United States Patent Application Publication No. 2004/0137982.

For example, the slot machine executes a slot game, in which symbols having been arranged on a display are rearranged, after each player's operation of betting a wager amount and then pressing a start switch. And then, if the predetermined number of scatter symbols have been included in the rearranges symbols on the display or the predetermined winning combination has been achieved on a payline, an award is provided according to its contents.

Further, in the slot machine, a special game will be executed in case where the predetermined condition has been met. The special game is generally a free game(s) without a need of betting a wager amount and also called as a feature game(s). In the special game as represented by a free game, there is a chance to get more awards.

However, a player's sense of expectancy was discursive in a special game because a trigger symbol to bring an award appears in the same probability in each game

### SUMMARY OF THE INVENTION

An aspect of the present invention provides a slot machine that includes: a display for displaying a unit game in which symbols having been arranged are rearranged in segmented areas and displaying, upon establishment of a predetermined condition, a special game including normal free games and a special free game; a counter for counting the number of specific symbols rearranged in the segmented areas; and a controller programmed to execute following (A) to (D): (A) a process for determining whether or not to provide an award to a player according to a rearranged mode of trigger symbols rearranged in the special game, (B) a process for counting the number of specific symbols during a predetermined number of normal free games in case where one or more specific symbols are included in symbols rearranged in the segmented areas, (C) a process for calculating the total number of counted specific symbols before an execution of the special free game that is executed after the normal free games, and (D) a process for increasing the number of trigger symbols to be rearranged in the special free game according to the total number of counted specific symbols.

Another aspect of the present invention provides a slot machine that includes: a display for displaying a unit game in which symbols having been arranged are rearranged in segmented areas and displaying, upon establishment of a predetermined condition, a special game including normal free games and a special free game; a counter for counting the number of specific symbols rearranged in the segmented areas; and a controller programmed to execute following (A) to (D): (A) a process for determining whether or not to provide an award to a player according to a rearranged mode of trigger symbols rearranged in the special game, (B) a process for counting the number of specific symbols during unit games before the special game in case where one or more specific symbols are included in symbols rearranged in the segmented areas, (C) a process for calculating the total number of counted specific symbols before an execution of the special free game that is executed after the normal free games, and (D) a process for increasing the number of trigger symbols to be rearranged in the special free game according to the total number of counted specific symbols.

Another aspect of the present invention provides a slot machine that includes: a display for displaying a unit game in which symbols having been arranged are rearranged in segmented areas and displaying, upon establishment of a predetermined condition, a special game including normal free games and a special free game; a counter for counting the number of specific symbols rearranged in the segmented areas; and a controller programmed to execute following (A) to (D): (A) a process for determining whether or not to provide an award to a player according to a rearranged mode of trigger symbols rearranged in the special game, (B) a process for counting the number of specific symbols during unit games before the special game and a predetermined number of normal free games in case where one or more specific symbols are included in symbols rearranged in the segmented areas, (C) a process for calculating the total number of counted specific symbols before an execution of the special free game that is executed after the normal free games, and (D) a process for increasing the number of trigger symbols to be rearranged in the special free game according to the total number of counted specific symbols.

Another aspect of the present invention provides a control method of a slot machine that includes a display for displaying a unit game in which symbols having been arranged are rearranged in segmented areas and displaying, upon establishment of a predetermined condition, a special game including normal free games and a special free game and a counter for counting the number of specific symbols rearranged in the segmented areas. The method includes: executing a process for determining whether or not to provide an award to a player according to a rearranged mode of trigger symbols rearranged in the special game; executing a process for counting the number of specific symbols by the counter during a predetermined number of normal free games in case where one or more specific symbols are included in symbols rearranged in the segmented areas; executing a process for calculating the total number of counted specific symbols before an execution of the special free game that is executed after the normal free games; and executing a process for increasing the number of trigger symbols to be rearranged in the special free game according to the total number of counted specific symbols.

### BRIEF DESCRIPTION OF THE DRAWINGS

FIG. 1A is a flow chart showing a general scheme of a slot machine in a first embodiment which is an example of a slot machine according to the present invention and a playing method thereof;

FIG. 1B is a flow chart showing a general scheme of a slot machine in a second embodiment which is an example of a slot machine according to the present invention and a playing method thereof;

FIG. 1C is a flow chart showing a general scheme of a slot machine in a third embodiment which is an example of a slot machine according to the present invention and a playing method thereof;

FIG. 2 is an explanatory diagram showing a screen example displayed on a display of the slot machine in the first embodiment according to the present invention;

FIG. 3 is an explanatory diagram showing segmented areas arranged in a matrix and provided on the display of the slot machine in the first embodiment according to the present invention;

FIG. 4 is a perspective view of the slot machine in the first embodiment according to the present invention;

FIG. 5 is a block diagram showing a control circuit of the slot machine in the first embodiment according to the present invention;

FIG. 6 is an explanatory diagram (I) showing a screen example of a special game executed on the display of the slot machine in the first embodiment according to the present invention;

FIG. 7 is an explanatory diagram (II) showing a screen example of a special game executed on the display of the slot machine in the first embodiment according to the present invention;

FIG. 8 is an explanatory diagram showing an increase number table of trigger symbols in the slot machine in the first embodiment according to the present invention;

FIG. 9 is an explanatory diagram showing a payout table of awards to be provided to a player in the slot machine in the first embodiment according to the present invention;

FIG. 10 is a flow chart showing procedures of a slot game processing in the slot machine in the first embodiment according to the present invention;

FIG. 11 is a flow chart showing procedures of a special game execution processing in the slot machine in the first embodiment according to the present invention;

FIG. 12 is an explanatory diagram showing a screen example of a slot game executed on the display of the slot machine in the first embodiment according to the present invention;

FIG. 13 is an explanatory diagram showing a screen example of a slot game executed on the display of the slot machine in the first embodiment according to the present invention;

FIG. 14 is a flow chart showing procedures of a slot game processing in the slot machine in the second embodiment according to the present invention;

FIG. 15 is a flow chart showing procedures of a special game execution processing in the slot machine in the second embodiment according to the present invention;

FIG. 16 is a flow chart showing procedures of a slot game processing in the slot machine in the third embodiment according to the present invention; and

FIG. 17 is a flow chart showing procedures of a special game execution processing in the slot machine in the third embodiment according to the present invention.

### DETAILED DESCRIPTION OF THE EMBODIMENT

### First Embodiment

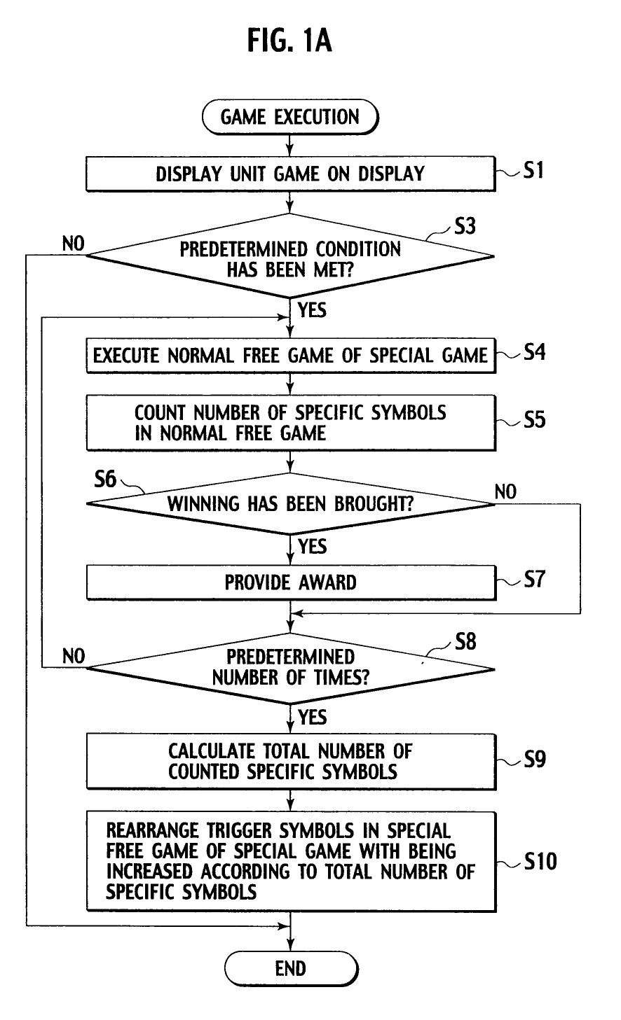

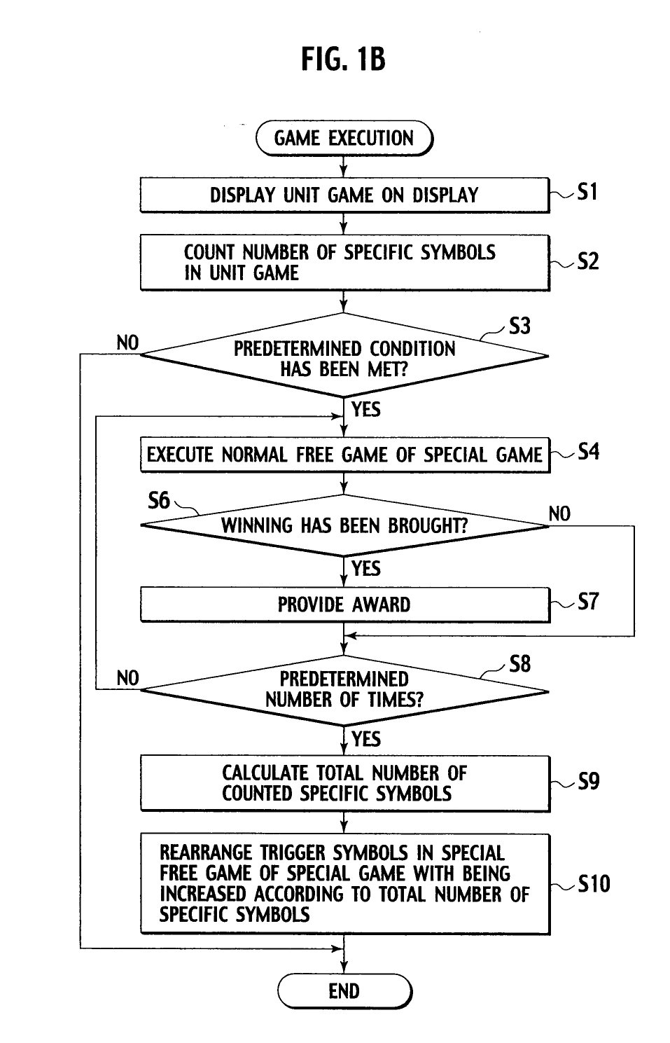

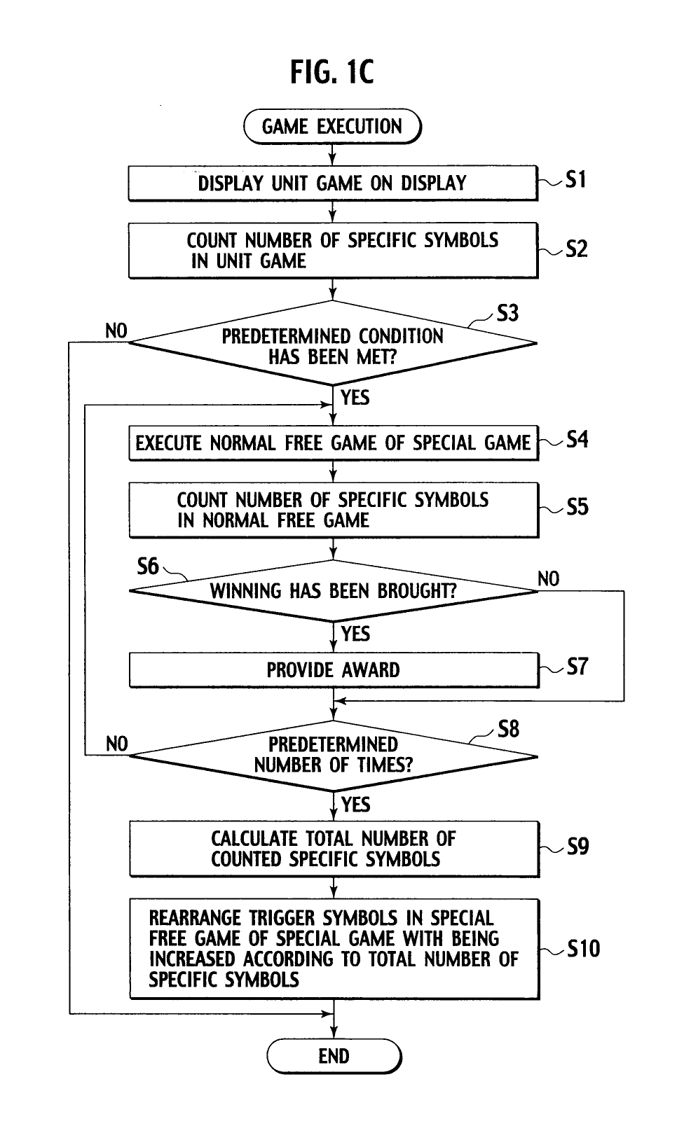

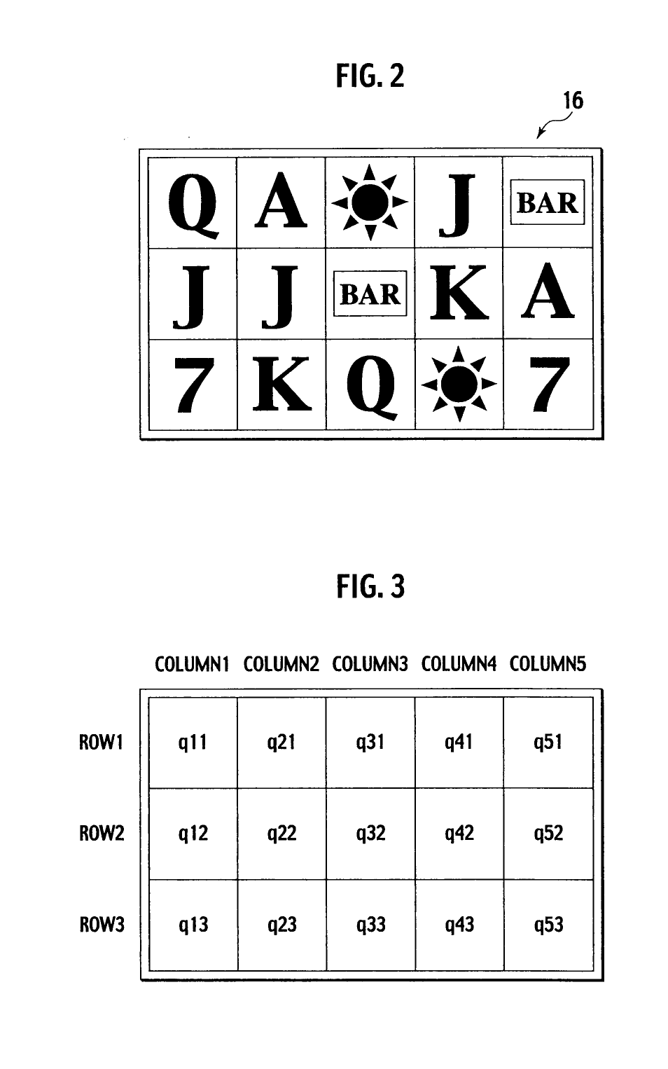

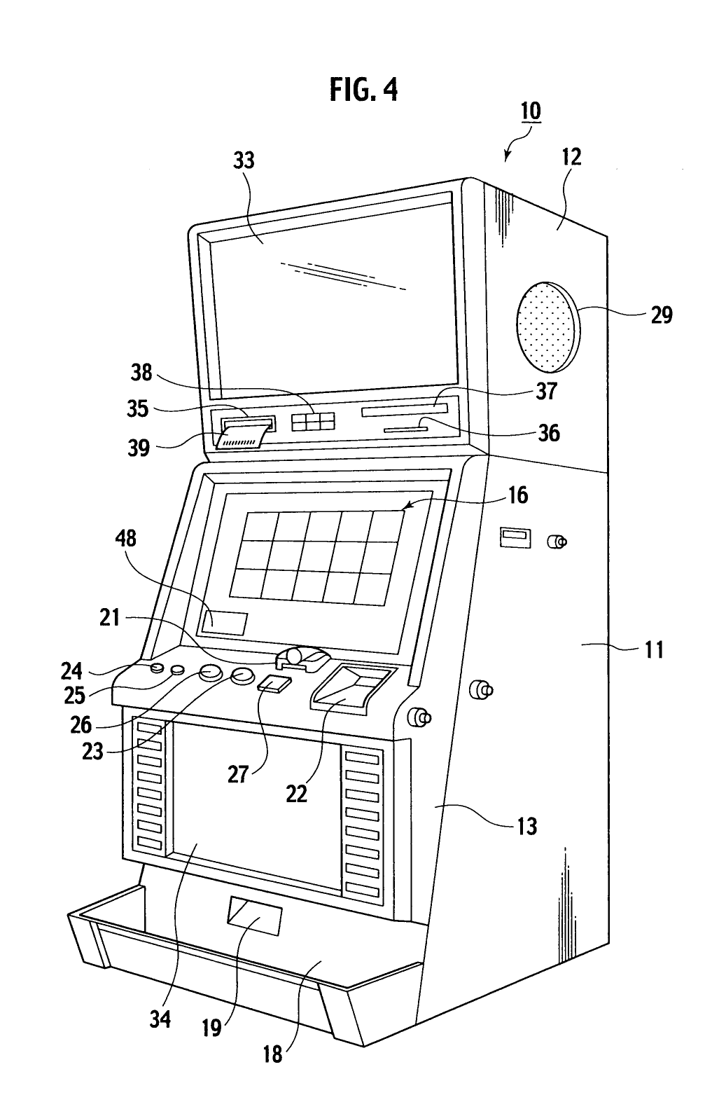

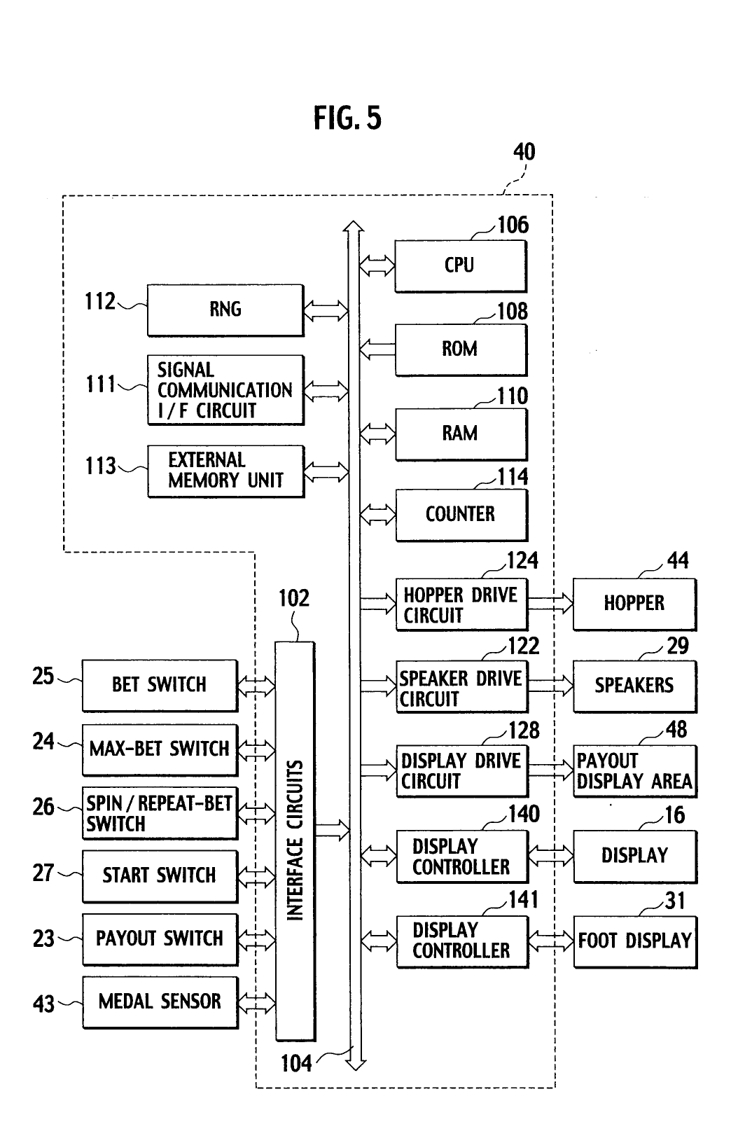

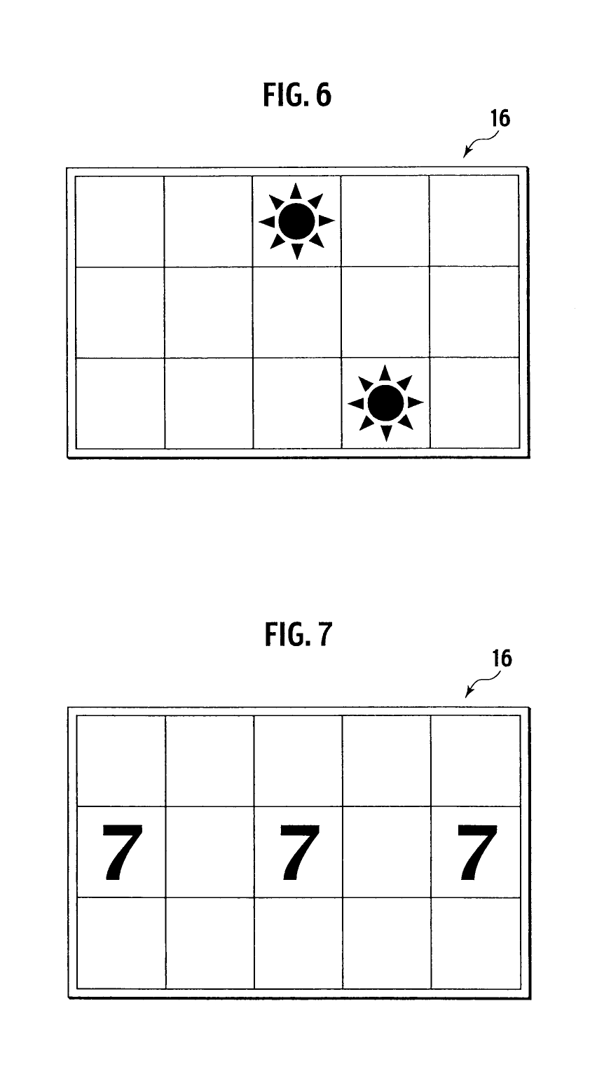

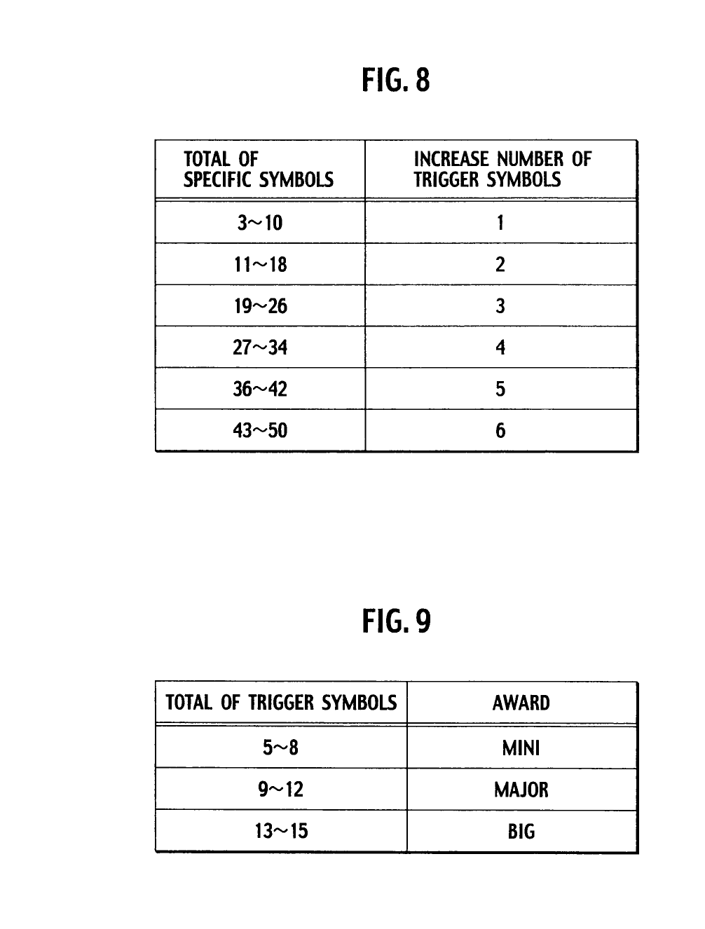

FIG. 1A is a flow chart showing a general scheme of a playing method of a slot machine in a first embodiment according to the present invention. FIG. 2 is an explanatory diagram showing a screen example displayed on a display of the slot machine in the first embodiment according to the present invention. FIG. 3 is an explanatory diagram showing segmented areas arranged in a matrix and provided on the display of the slot machine in the first embodiment according to the present invention. FIG. 4 is a perspective view of the slot machine in the first embodiment according to the present invention. FIG. 5 is a block diagram showing a control circuit of the slot machine in the first embodiment according to the present invention. FIGS. 6 and 7 are explanatory diagrams each showing a screen example sown as a special game of the slot machine in the first embodiment according to the present invention. FIG. 8 is a table showing relations between the total stock number of specific symbols and the increase number of trigger symbols in a special free game in the slot machine in the first embodiment according to the present invention. FIG. 9 is a table showing relations between the number of trigger symbols rearranged in a special game and an award to be provided to a player in the slot machine in the first embodiment according to the present invention.

A display 16 is provided on a front face of a cabinet 11 of a slot machine 10 shown in FIG. 4. The display 16 includes fifteen segmented areas q11 to q53 as shown in FIG. 3. The segmented areas q11 to q53 are arranged in a matrix composed of first to fifth columns and first to third rows.

Symbols having been arranged as shown in FIG. 2 in the above-mentioned segmented areas q11 to q53 shown in FIG. 3 are rearranged in each execution of unit games in the slot machine 10 according to one example of the present invention shown in FIG. 4. For example, a unit game can be executed by a scrolling display and a stopped display in the segmented areas q11 to q53 on the display 16 by displaying on a liquid crystal panel.

Symbols displayed on the display 16 include seven kinds of symbols such as “7”, “BAR”, “SUN”, “A (Ace of cards)”, “K (King of cards)”, “Q (Queen of cards)” and “J (Jack of cards)”.

And then, an award of credits is determined based on a rule predetermined in a payout table to provide a payout of the credits for the determined award after symbols have been rearranged in the segmented areas q11 to q53 in a unit game. Subsequently, symbols q11 to q53 will be rearranged due to a start of a next unit game.

As shown in FIG. 1A, the slot machine 10 according to the one example of the present invention displays a unit game on the display 16 shown in FIG. 4, in which symbols having been arranged are rearranged as described above (step S1).

This unit game can be made playable through a player's bet of a wager amount. Specifically, a bet of a wager amount can be placed by a player's insertion of coins or medals, which are cashable credits capable of being exchanged into cash, into the slot machine 10. In addition, a bet of a wager amount also can be placed through a player's operation to appropriate restricted credits, which are electronically stored in the slot machine 10 and continuously usable as a wager amount until being exchanged into cash, to a wager amount as much as specified by the player.

Note that a unit of a wager amount capable of being bet with the above-mentioned cashable or restricted credits will be called as “credit” in the following descriptions. For example, “one credit” will be bet as a wager amount in case where a player has inserted one medal or coin into the slot machine 10 for the wager amount. In addition, for example, “two credits” will be bet as a wager amount in case where two restricted credits have been appropriated to the wager amount through a player's operation of the slot machine 10.

Next, as shown in FIG. 1A, the slot machine 10 determines whether or not the predetermined condition for a special game execution has been met (step S3). For example, a special game is also called as a free game(s) (feature game(s)), for example. For example, whether or not the predetermined condition has been met can be determined based on whether or not a condition establishment sortition was hit, which is executed based on a random number generated by an RNG 112 shown in FIG. 5 at each of displaying a unit game on the display.

Then, as shown in FIG. 1A, if the predetermined condition has not been met (NO in step S3), the slot machine 10 stops a series of processes and displays a unit game on the display again in step S1.

On the other hand, if the predetermined condition has been met (YES in step S3), the slot machine 10 executes normal free games in a special game (step S4).

The special game is a set of the predetermined number of slot games (e.g. ten games) executed as free games. The special game is composed of normal free games and a special free game. The special free game is a last unit game during the special game. In case where the special game is executed with ten games, the special game may be executed in such a way that nine normal free games are executed and the last one special free game is executed.

Subsequently, the slot machine 10 counts the number of specific symbols had been rearranged in the normal free games using a counter 114 (see FIG. 5) (step S5). For example, in case where the specific symbol is a “SUN” symbol and the two “SUN” symbols has been rearranged on the display 16 as shown in FIG. 6, the number of specific symbols is counted as two.

Parallel to the above-mentioned process of counting the number of specific symbols, the slot machine 10 determines whether or not a winning has been achieved according to symbols having been arranged in the segmented areas q11 to q53 (step S6). In other words, the slot machine 10 determines whether or not a condition for providing an award has been met.

In this step S6, the slot machine 10 determines whether or not the rearranged mode of symbols rearranged in the segmented areas q11 to q53 matches with any one of rearranged symbol combinations defined as eligibles for providing a payout in the payout table with reference to the payout table stored in a ROM 108.

Then, if it matches with one rearranged symbol combination defined in the payout table (YES instep S6), an award is provided to a player for a winning achievement (step S7).

On the other hand, the above-mentioned symbol combination rearranged in step S17 does not match with any of the rearranged modes defined as the eligibles in the payout table (NO in step S6), the slot machine 10 shifts the process flow to step S8 without a winning achievement.

Next, the slot machine 10 determines whether or not the number of executed slot games of the normal free games has reached up to the predetermined number of times (nine times in the present embodiment) (step S8).

Then, if the number of executed slot games of the normal free games has not reached up to the predetermined number of times (NO in step S8), the slot machine 10 shifts the process flow to step S4. If the number of executed slot games of the normal free games has reached up to the predetermined number of times (YES in step S8), the slot machine 10 shifts the process flow to step S9.

Next, the slot machine 10 calculates the total number of the specific symbols counted in step S5 during the slot games executed as the normal free games (step S9).

Then, the slot machine 10 rearranges trigger symbols to bring an award, the number of which has been increased according to the total number of the specific symbols calculated in step S9, in the special free game executed after the executions of the predetermined number of the normal free games (step S10).

In step S10, the slot machine 10 determines the increase number of trigger symbols to be rearranged in the segmented areas q11 to q53 with reference to an increase number table of trigger symbols (see FIG. 8) stored in an external memory unit 113. For example, if the calculated total of the specific symbols has been twenty, the number of trigger symbols to be rearranged becomes three after being increased. In this case, if the trigger symbol is a “7” symbol, the slot machine 10 starts a special free game with the three trigger symbols having been preliminarily rearranged as shown in FIG. 7.

As a result of the above-mentioned processes, the slot machine 10 according to the first embodiment counts the specific symbols rearranged during normal free games and can determine to increase the total number of trigger symbols in a special free game according to the number of the counted specific symbols. Therefore, since the number of trigger symbols to be rearranged in a special free game is expected to be increased as an increase of the number of the counted specific symbols, the slot machine 10 in the first embodiment can focus a player's sense of expectancy on a special free game.

In addition, since a sense of expectancy for an increase of trigger symbols is encouraged every rearrangement of specific symbols in normal free games, the slot machine 10 can make a player to play games continuously without boring.

Next, the slot machine in the first embodiment according to the present invention will be explained in detail. As shown in FIG. 4, the slot machine 10 in the present embodiment includes the cabinet 11, a top box 12 provided on top of the cabinet 11 and a main door 13 provided at a front face of the cabinet 11. The display 16 is disposed on the front of the main door 13. The display 16 includes the fifteen segmented areas q11 to q53 as shown in FIG. 3 that are arranged in a matrix composed of the first to fifth columns and the first to third rows.

Any one of seven kinds of symbols, “7”, “BAR”, “SUN”, “A (Ace of cards)”, “K (King of cards)”, “Q (Queen of cards)” and “J (Jack of cards)” will be displayed in each of the segmented areas q11 to q53.

In the slot machine 10 of the present embodiment, one slot game (unit game) is executed by rearranging symbols in the segmented areas q11 to q53 as shown in FIG. 2. Although slot games can be generally played by betting a wager amount using gaming media, slot games can be played without betting a wager amount during the special game (the free games) executed after an establishment of the predetermined condition.

Note that, in the present embodiment, although medals are used as gaming media at slot game executions (however, except for the free games), media for slot games are not limited to medals and, for example, medals, tokens, electronic money or other equivalent electronic value information (credits) may be also used.

Various input buttons 23 for accepting player's operations relating to game plays, a coin acceptor 21 for accepting coins and a bill validator 22 for accepting valid bills are disposed beneath the display 16. Note that the bill validator 22 may be configured to be able to read a bar-coded ticket 39.

Various operational switches are provided near the medal insertion slot 21 and the bill validator 22. A payout switch 23, a max-bet switch 24, a bet switch 25, a spin/repeat-bet switch 26 and a start switch 27 are provided as the operational switches.

The bet switch 25 is a switch for determining a credit amount to be bet on a slot game executed on the display 16 and one credit corresponding to one medal is bet each pressing of the bet switch 25 as explained later.

The spin/repeat-bet switch 26 is a switch for betting a credit amount again without changing a bet amount had been bet on the last slot game using the above-mentioned bet switch 25.

The start switch 27 is a switch for starting a slot game after betting a desired credit amount. A slot game is started on the display 16 due to the start switch 27 being pressed after a credit bet by medals being inserted into the medal insertion slot 21 or by the bet switch 25 being pressed.

The payout switch 23 is a switch for paying out medals being inserted. The medals to be paid out will be discharged from a medal payout opening 19 opened at the front lower of the main door 13 and pooled on a medal tray 18.

The max-bet switch 24 is a switch for betting a maximum credit amount (e.g. equivalent to thirty medals) capable of being bet on one slot game by a one-time operation.

A foot display 34 is disposed on the lower front of the main door 13 to display predetermined image screens based on image display control data included in a game software being executed.

An upper display 33 is disposed on the front of the top box 12. The upper display 33 has a liquid crystal panel to display the payout table or the like.

In addition, speakers 29 are provided on the top box 12. A ticket printer 35, a card reader 36, a data display 37 and a keypad 38 are disposed beneath the upper display 33. The ticket printer 35 prints a bar-code, into which data, such as a credit amount, time and date and an identification number of the slot machine 10 are encoded, on a ticket and outputs it as a bar-code ticket 39.

A player can make the bar-code ticket 39 read by another slot machine to use it as a wager amount for playing a slot game at the other slot machine and can exchange the bar-code ticket 39 into bills and so on at a predetermined site in an amusement facility (e.g. a cashier in a casino).

A smart card can be inserted into the card reader 36 and the card reader 36 reads out data from the inserted smart card and writes data onto the smart card. A smart card is a card carried by a player and stores identification data of the player, history data of the player's game plays and so on.

The smart card may be able to store data corresponding to coins, bills ore credits. In addition, a magnetic stripe card may be employed instead of the smart card. The data display 37 is composed of a fluorescence display or the like to display data read out by the card reader 36, data input via the keypad 38 by a player or the like.

Alternatively, a card employing a RFID system and can be read-out and written-into data contactlessly. The keypad 38 can accept commands and data relating to ticket issuance or the like.

FIG. 5 is a block diagram showing control circuit of the slot machine according to the present embodiment. A machine controller 40 shown in the diagram is a microcomputer and includes interface circuits 102, an I/O bus 104, a CPU 106, the ROM 108, a RAM 110, a signal communication I/F circuit 111, the RNG 112, the external memory unit 113, the counter 114, a speaker drive circuit 122, a hopper drive circuit 124, a display drive circuit 128 and display controllers 140 and 141.

The interface circuits 102 are connected to the I/O bus 104 and the I/O bus 104 transmits data signals and address signals with the CPU 106.

The start switch 27 is connected to the interface circuits 102. A start command output from the start switch 27 is transmitted to the CPU 106 via the I/O bus 104 after being converted into a predetermined signal by the interface circuits 102.

Furthermore, the bet switch 25, the max-bet switch 24, the spin/repeat-bet switch 26 and the payout switch 23 are connected to the interface circuits 102. Each switching signal output from the switches 25, 24, 26 and 23 is transmitted to the CPU 106 via the I/O bus 104 after being converted into a predetermined signal by the interface circuits 102.

In addition, a medal sensor 43 is connected to the interface circuits 102. The medal sensor 43 is a sensor for detecting a medal (s) had been inserted into the medal insertion slot 21 and disposed inside a medal insertion point of the medal insertion slot 21. A detection signal output from the medal sensor 43 is transmitted to the CPU 106 via the I/O bus 104 after being converted into a predetermined signal by the interface circuits 102.

The ROM 108 for storing system programs and the RAM 110 for storing various data are connected to the I/O bus 104. The RAM 110 includes areas for storing a variety of information and for managing flags or the like.

The ROM 108 stores the payout table. The payout table contains correspondence relations between conditions for providing a payout and credit payout amounts for establishments of the conditions. The conditions for providing a payout are defined based on symbol combination rearranged in the segmented areas q11 to q53. The rearranged modes of symbols defined as eligibles for providing a payout can be defined based on the number of scatter symbols rearranged in a slot game or based on patterns of winning combinations achieved on a payline(s) set on the segmented areas q11 to q53. In a slot game of the present embodiment, the CPU 106 determines whether or not to provide a payout (to payout credits) and a credit payout amount (a credit amount to be paid out) based on the payout table and symbols stopped in the segmented areas q11 to q53.

The CPU 106 is triggered by the start switch 27 receiving a game start operation and then reads out the game execution programs from the ROM 108 to execute a slot game. Specifically, the game execution programs are programmed to execute a slot game, in which symbols are displayed with being changed consecutively in the segmented areas q11 to q53 and then stopped and a payout credit amount is provided based on the payout table stored in the ROM 108 in case where the stopped symbols has achieved combination eligible for providing a payout.

The RNG 112, the signal communication I/F circuit 111, the external memory unit 113, the counter 114, the display controllers 140 and 141, the hopper drive circuit 124, the speaker drive circuit 122 and the display drive circuit 128 are connected to the I/O bus 104.

The signal communication I/F circuit 111 is connected to a hall server or the like to transmit history data of game plays executed at the slot machine 10 or the like to the hall server. In addition, it receives a variety of data transmitted from the hall server.

The RNG 112 generates random numbers for determining whether or not to bring a winning combination or a jackpot in a slot game executed on the display 16.

The external memory unit 113 stores the increase number table with respect to relations between the total number of specific symbols counted during the normal free games executed as the special game after the predetermined condition establishment and the increase number of trigger symbols to be increased in the special free game according to the total number of specific symbols.

The counter 114 counts the number of specific symbols rearranged in the segmented areas q11 to q53 during the normal free games. Counting data of specific symbols counted by the counter 114 is transmitted to the CPU 106 via the I/O bus 104 after being converted into a predetermined signal by the interface circuits 102.

The display drive circuit 128 controls displaying a payout amount in a payout amount segmented area 48 provided at the lower-left area on the display 16.

The speaker drive circuit 122 outputs sound data to the speakers 29. Specifically, the CPU 106 reads out the sound data stored in the ROM 108 and transmits the sound data to the speaker drive circuit 122 via the I/O bus 104. As a result, predetermined sound effects are output from the speakers 29.

The hopper drive circuit 124 outputs a payout command to the hopper 44 when a payout is to be awarded. Specifically, the CPU 106 outputs a drive command to the hopper drive circuit 124 via the I/O bus 104 when receiving the payout command from the payout switch 23. As a result, the hopper 44 pays out medals equivalent to current credits stored in a prescribed memory area in the RAM 110.

On receiving an image display command output from the CPU 106, the display controller 140 generates a drive command for driving the display 16 based on the image display command and then outputs the generated drive command to the display 16.

On receiving an image display command output from the CPU 106, the display controller 140 generates two frame memories to be displayed with being overlaid on the display 16 based on the image display command and then stores them in the RAM 110. One of the two frame memories, a front frame memory is generated to display scrolling images in the segmented areas q11 to q53 and another of the two frame memories, a rear frame memory is generated to display symbols that has been determined by the CPU 106 to be rearranged in the segmented areas q11 to q53.

In addition, on receiving an image display command output from the CPU 106, the display controller 140 generates a drive command for driving the display 16 based on the image display command and then outputs the generated drive command to the display 16. The display controller 140 executes a control for displaying each symbol of the rear frame memory visibly on the display 16. As a result, a prescribed image is displayed on the display 16.

The display controller 141 executes a control for displaying a prescribed image on the upper display 33. Specifically, the CPU 106 generates an image display command according to the prescribed image and transmits the image display command to the display controller 141 via the I/O bus 104. On receiving the image display command output from the CPU 106, the display controller 141 generates a drive command for driving the upper display 33 based on the image display command and then outputs the generated drive command to the upper display 33. As a result, the prescribed image is displayed on the upper display 33. This image display can be done by a still image or a movie image.

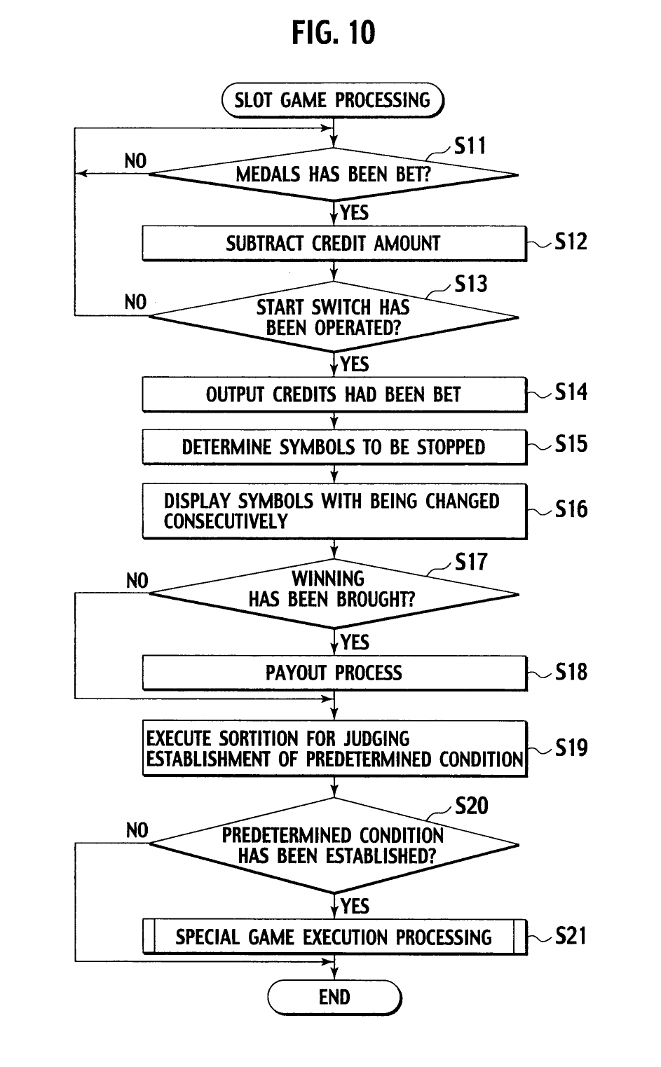

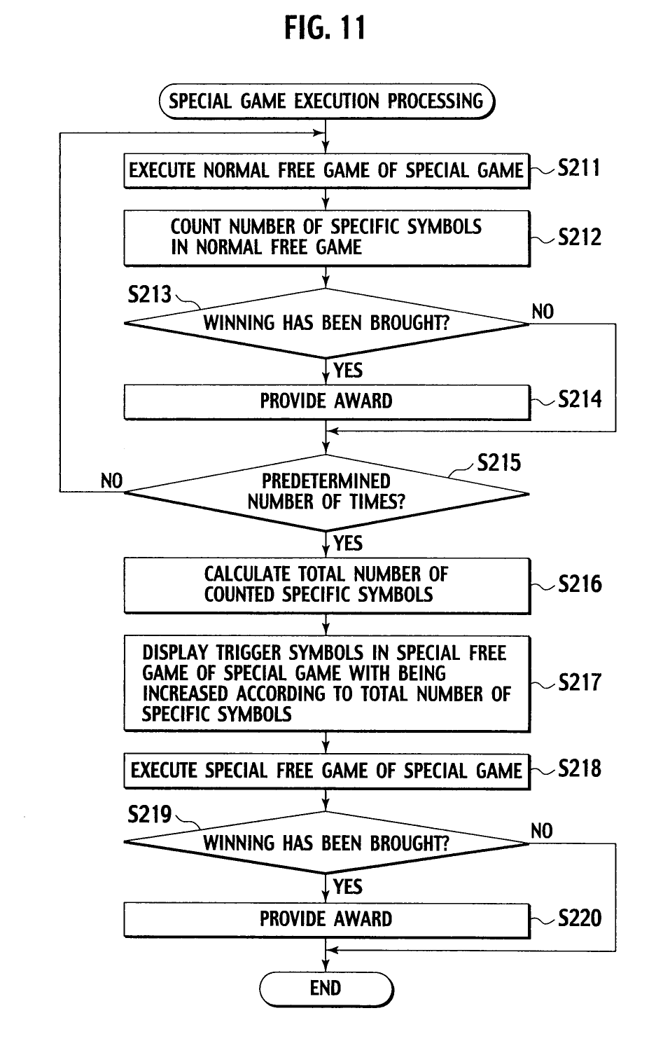

Next, operations of the slot machine 10 in the present embodiment will be explained with reference to flow charts shown in FIGS. 10 and 11. FIGS. 10 and 11 are flow charts showing procedures of the slot game processing and the special game processing executed by the CPU 106 according to the game execution programs stored in the ROM 108.

First, on entering the slot game processing shown in FIG. 10, the CPU 106 determines whether or not credits have been bet in step S11. In this process, the CPU 106 determines whether or not a signal output from the bet switch 25 on the bet switch 25 being pressed or a signal output from the max-bet switch 24 on the max-bet switch 24 being pressed has been received. If it is determined that credits have not been bet, the process flow returned to step S11.

On the other hand, if it is determined that credits have been bet in step S11, the CPU 106 proceeds to step S12 to subtract a credit amount had been bet from credits stored in the RAM 11.

Next, in step S13, the CPU 106 determines whether or not the start switch 27 has been pressed. In this process, the CPU 106 determines whether or not to receive the signal output from the start switch 27 on the start switch 27 being pressed.

If it is determined that the start switch 27 has not been pressed, the CPU 106 returns the process flow to step S11. Note that, in case where the start switch 27 has not been pressed (for example, a terminating command of game play has been input without the start switch 27 being pressed), the CPU 106 cancels the subtracting result of the credit amount.

Then, instep S13, if it is determined that the start switch 27 has been pressed, the CPU 106 shifts from step S13 to step S14 and transmits the credit amount had been bet to a payout controller 3. Parallel to this, in step S15, the CPU 106 determines symbols to be stopped. In this stop symbol determination process, the CPU 106 determines symbols to be displayed (rearranged) in the segmented areas q11 to q53 by executing a stop symbol determination program which is one of the game execution programs stored in the ROM 108.

By this stop symbol determination process, each symbol to be rearranged in the segmented areas q11 to q53 shown in FIG. 5 is determined as one of the seven kinds of symbols, “7”, “BAR”, “SUN”, “A (Ace of cards)”, “K (King of cards)”, “Q (Queen of cards)” and “J (Jack of cards)”.

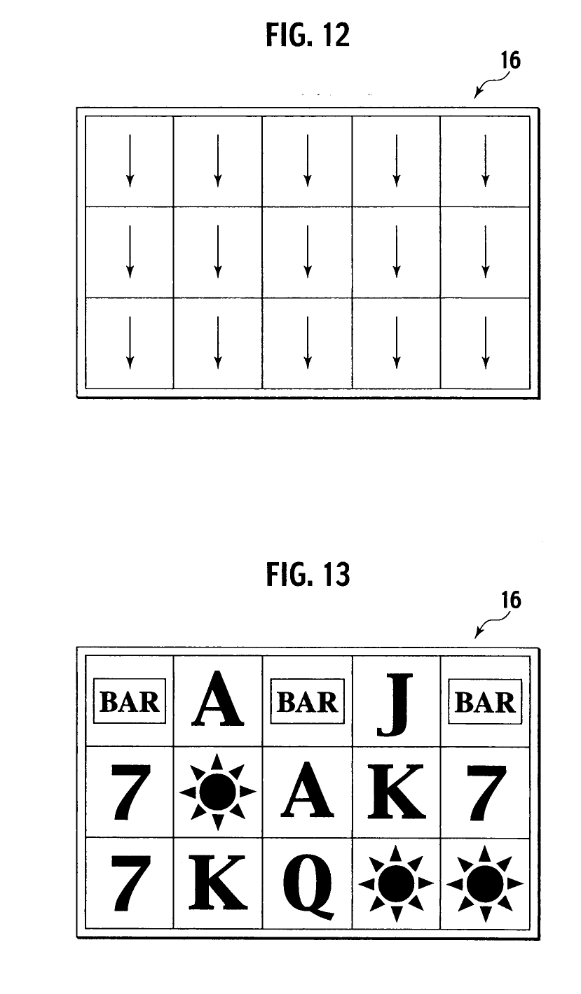

Next, in step S16, the CPU 106 executes symbol changing display process. This process is a process in which symbols are started to be displayed with being changed consecutively in the segmented areas q11 to q53 as shown in FIG. 12 and then the symbols are stopped in the segmented areas q11 to q53 as shown in FIG. 13. By this start and stop process of changing display, symbols are rearranged in the segmented areas q11 to q53.

Upon a termination of the symbol changing display process, the CPU 106 shifts to step S17 and determines whether or not a winning has been achieved based on the symbols rearranged in the segmented areas q11 to q53. Specifically, the CPU 106 determines whether or not a condition for providing an award has been met.

In this step S17, the CPU 106 determines whether or not the symbol combination rearranged in the above-mentioned step S16 matches with any one of the rearranged symbol modes defined as eligibles for providing a payout in the payout table with reference to the payout table stored in the ROM 108

Then, if it matches with the rearranged symbol mode defined in the payout table, the payout amount corresponding to the rearranged symbol mode is determined as a credit payout for an achievement of a winning and the process flow shifts from step S17 to step S18.

On the other hand, if the symbol combination rearranged in the above-mentioned step S17 does not match with any one of the rearranged symbol modes defined as eligibles for providing a payout in the payout table, the CPU 106 shifts the process to after-mentioned step S19 without an achievement of a winning.

In step S18, the CPU 106 executes a payout process for paying out credits according to a winning result in the above-mentioned step S16. In this payout process, the CPU 106 accumulates the credit payout amount in the above-mentioned step S17 into the credit amount stored in the RAM 111.

In step S19, the CPU 106 executes a sortition to determine whether or not the predetermined condition for a start of free games using a random number generated by the RNG 112. Then, in step S20, the CPU 106 determines whether or not the sortition result indicates an establishment of the predetermined condition.

If the sortition result does not indicate an establishment of the predetermined condition (indicates non-establishment) (NO in step S20), the CPU 106 returns to the above-mentioned step S11 to execute the next slot game processing. If the sortition result indicates an establishment of the predetermined condition (YES in step S20), the CPU 106 executes a special game execution processing in step S21 and then returns to the above-mentioned step S11 to execute the next slot game processing.

Within the special game execution processing of step S21, the CPU 106 executes a normal free game of the special game in step S211 as shown in FIG. 11. The CPU 106 generates the image display command of the normal free game to display the normal free game on the display 16 (step S211).

Subsequently, the CPU 106 output a command to the counter 114 (see FIG. 5) for counting the number of the specific symbols rearranged in the normal free games (step S212). And then, the number of specific symbols in the normal free games is counted by the counter 114.

Parallel to the counting process of the number of specific symbols in the above-mentioned step S212, the CPU 106 determines whether or not a winning has been brought based on the symbols rearranged in the segmented areas q11 to q53 in the normal free game (step S213). In other words the CPU 106 judges whether or not a condition for providing an award has been met.

In this step S213, the CPU 106 determines whether or not the rearranged mode of the symbols rearranged in the segmented areas q11 to q53 matches with any one of rearranged symbol combinations defined as eligibles for providing a payout for a normal free game in the payout table with reference to the payout table stored in a ROM 108.

And then, if it matches with one rearranged symbol combination defined in the payout table (YES in step S213), an award is provided to a player for a winning achievement (step S214).

On the other hand, the above-mentioned symbol combination rearranged in step S17 does not match with any of the rearranged modes defined as the eligibles in the payout table (NO in step S213), the CPU 106 shifts the process flow to step S215 without a winning achievement.

Next, the CPU 106 determines whether or not the number of executed slot games of the normal free games has reached up to the predetermined number of times (step S215).

Then, if the number of executed slot games of the normal free games has not reached up to the predetermined number of times (NO in step S215), the CPU 106 shifts the process flow to step S211. If the number of executed slot games of the normal free games has reached up to the predetermined number of times (YES in step S215), the CPU 106 shifts the process flow to step S216.

Next, the CPU 106 calculates the total number of the specific symbols counted in step S212 during the slot games executed as the normal free games (step S216).

Then, the CPU 106 rearranges trigger symbols to bring an award, the number of which has been increased according to the total number of the specific symbols calculated in step S216, in the special free game executed after the executions of the predetermined number of the normal free games (step S217).

In step S217, the slot machine 10 determines the increase number of trigger symbols to be rearranged in the segmented areas q11 to q53 with reference to the increase number table of trigger symbols (see FIG. 8) stored in the external memory unit 113.

Next, the CPU 106 executes the special free games (step S211). At this time, the CPU 106 generates an image display command, in which the increase number of trigger symbols determined in step S217 is preliminarily rearranged, and then displays the special free game on the display 16.

And then, the CPU 106 determines whether or not a winning has been brought in the special free game base on the symbols rearranged in the segmented area q11 to q53 (step S219). In other words the CPU 106 judges whether or not a condition for providing an award has been met.

In this step S219, the CPU 106 determines whether or not the rearranged mode of the symbols rearranged in the segmented areas q11 to q53 matches with any one of rearranged symbol combinations defined as eligibles for providing an award for a special free game in the payout table with reference to the payout table stored in a ROM 108. For example, the CPU 106 determines a rank of the award according to the total number of the trigger symbols rearranged in the segmented areas q11 to q53 with reference to the payout table as shown in FIG. 9. The ranks of award are classified as follows: “MINI” when the total number of the rearranged trigger symbols is five to eight, “MAJOR” when the total number of the rearranged trigger symbols is nine to twelve and “BIG” when the total number of the rearranged trigger symbols is thirteen to fifteen. A payout for each rank, for example, 1,000 for “MINI”, 5,000 for “MAJOR” or 10,000 for “BIG”, is provided to a player as an award.

If the symbols rearranged in the segmented areas q11 to q53 have not been brought a result for providing an award to a player (NO in step S219), the CPU 106 terminates the series of processes of the special game.

On the other hand, if the symbols rearranged in the segmented areas q11 to q53 have been brought a result for providing an award to a player (YES in step S219), the CPU 106 provides an award to the player for an award winning (step S220). And then, the CPU 106 executes a payout process for paying out credits corresponding to a payout amount set for an award to be provided. Subsequently, the special game execution processing is terminated.

As described above, in the present embodiment, the CPU 106 constitutes a controller in the claims.

According to the slot machine 10 as configured above, the number of trigger symbols to be rearranged in a special free game is increased according to the total number of specific symbols rearranged in normal free games. Therefore, since the number of trigger symbols to be rearranged in a special free game is expected to be increased as an increase of the number of specific symbols in normal free games, the slot machine 10 in the first embodiment can focus a player's sense of expectancy on a special free game.

In addition, since a sense of expectancy for an increase of trigger symbols is encouraged every rearrangement of specific symbols in normal free games, the slot machine 10 according to the first embodiment can make a player to play games, even if they are normal free games, continuously without boring.

Note that, in step S217 of FIG. 11, the increase number table for determining the increase number of trigger symbols to be rearranged in the segmented areas q11 to q53 may be implemented in a program in the ROM 108 instead of being stored in the external memory unit 113.

### Second Embodiment

Next, a slot machine 10 and a playing method thereof according to a second embodiment of the present invention will be explained. Since it has substantively the same configuration as those of the slot machine 10 in the first embodiment, redundant explanations will be omitted.

FIG. 1B is a flow chart showing a general scheme of the playing method of the slot machine according to the second embodiment of the present invention.

As shown in FIG. 1B, the slot machine 10 according to the second embodiment of the present invention displays a unit game on the display 16 shown in FIG. 4, in which symbols having been arranged are rearranged (step S1).

Next, as shown in FIG. 1B, the slot machine 10 counts the number of the specific symbols rearranged in the unit games before a special game using the counter 114 (see FIG. 5) (step S2). For example, in case where the specific symbol is a “SUN” symbol and two “SUN” symbols are rearranged on the display 16 as shown in FIG. 6, the counter 114 counts the number of the specific symbols as two.

Next, as shown in FIG. 1B, the slot machine 10 determines whether or not the predetermined condition for a special game execution has been met (step S3). For example, a special game is also called as a free game(s) (feature game(s)), for example. For example, whether or not the predetermined condition has been met can be determined based on whether or not a condition establishment sortition was hit, which is executed based on a random number generated by an RNG 112 shown in FIG. 5 at each of displaying a unit game on the display.

Then, as shown in FIG. 1B, if the predetermined condition has not been met (NO in step S3), the slot machine 10 stops a series of processes and displays a unit game on the display again in step S1.

On the other hand, if the predetermined condition has been met (YES in step S3), the slot machine 10 executes normal free games in a special game (step S4).

The special game is a set of the predetermined number of slot games (e.g. ten games) executed as free games. The special game is composed of normal free games and a special free game. The special free game is a last unit game during the special game. In case where the special game is executed with ten games, the special game may be executed in such a way that nine normal free games are executed and the last one special free game is executed.

And then, the slot machine 10 determines whether or not a winning has been achieved according to symbols having been arranged in the segmented areas q11 to q53 (step S6). In other words, the slot machine 10 determines whether or not a condition for providing an award has been met.

In this step S6, the slot machine 10 determines whether or not the rearranged mode of symbols rearranged in the segmented areas q11 to q53 matches with any one of rearranged symbol combinations defined as eligibles for providing a payout in the payout table with reference to the payout table stored in a ROM 108.

Then, if it matches with one rearranged symbol combination defined in the payout table (YES in step S6), an award is provided to a player for a winning achievement (step S7).

On the other hand, the above-mentioned symbol combination rearranged in step S4 does not match with any of the rearranged modes defined as the eligibles in the payout table (NO in step S6), the slot machine 10 shifts the process flow to step S8 without a winning achievement.

Next, the slot machine 10 determines whether or not the number of executed slot games of the normal free games has reached up to the predetermined number of times (nine times in the present embodiment) (step S8).

Then, if the number of executed slot games of the normal free games has not reached up to the predetermined number of times (NO in step S8), the slot machine 10 shifts the process flow to step S4. If the number of executed slot games of the normal free games has reached up to the predetermined number of times (YES in step S8), the slot machine 10 shifts the process flow to step S9.

Next, the slot machine 10 calculates the total number of the specific symbols counted in step S2 during the unit games (slot games) before the special game (step S9).

Then, the slot machine 10 rearranges trigger symbols to bring an award, the number of which has been increased according to the total number of the specific symbols calculated in step S9, in the special free game executed after the executions of the predetermined number of the normal free games (step S10).

In step S10, the slot machine 10 determines the increase number of trigger symbols to be rearranged in the segmented areas q11 to q53 with reference to an increase number table of trigger symbols (see FIG. 8) stored in an external memory unit 113.

As a result of the above-mentioned processes, the slot machine 10 according to the second embodiment counts the specific symbols rearranged during unit games before a special game and can determine to increase the number of trigger symbols in a special free game according to the total number of the counted specific symbols. Therefore, since the number of trigger symbols to be rearranged in a special free game is expected to be increased as an increase of the number of the counted specific symbols, the slot machine 10 in the second embodiment can focus a player's sense of expectancy on a special free game.

In addition, since a sense of expectancy for an increase of trigger symbols is encouraged every rearrangement of specific symbols in unit games before a special game, the slot machine 10 according to the second embodiment can make a player to play games continuously without boring.

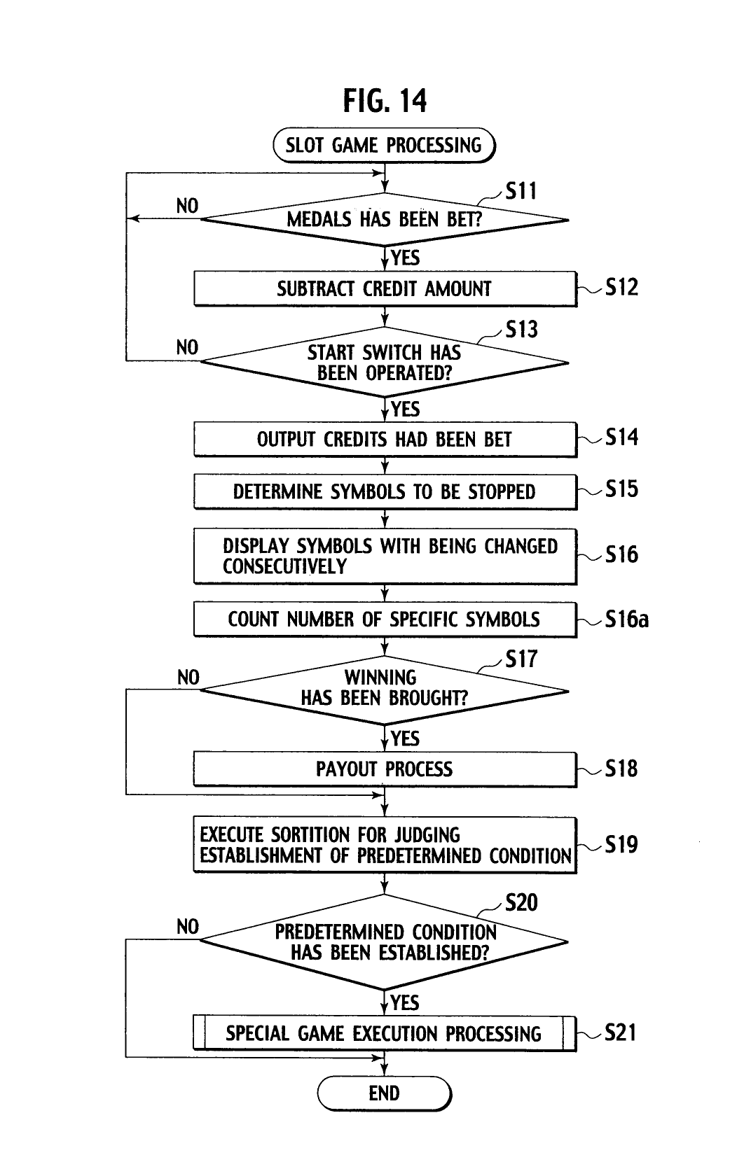

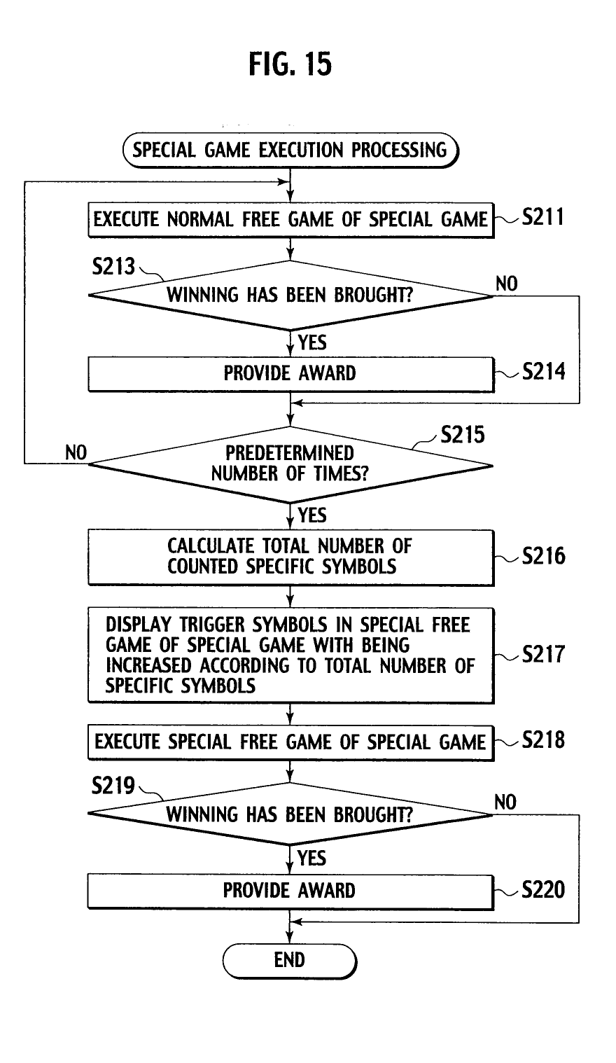

Next, operations of the slot machine 10 in the present embodiment will be explained with reference to flow charts shown in FIGS. 14 and 15. FIGS. 14 and 15 are flow charts showing procedures of the slot game processing and the special game processing executed by the CPU 106 according to the game execution programs stored in the ROM 108.

First, on entering the slot game processing shown in FIG. 14, the CPU 106 determines whether or not credits have been bet in step S11. In this process, the CPU 106 determines whether or not a signal output from the bet switch 25 on the bet switch 25 being pressed or a signal output from the max-bet switch 24 on the max-bet switch 24 being pressed has been received. If it is determined that credits have not been bet, the process flow returned to step S11.

On the other hand, if it is determined that credits have been bet in step S11, the CPU 106 proceeds to step S12 to subtract a credit amount had been bet from credits stored in the RAM 11.

Next, in step S13, the CPU 106 determines whether or not the start switch 27 has been pressed. In this process, the CPU 106 determines whether or not to receive the signal output from the start switch 27 on the start switch 27 being pressed.

If it is determined that the start switch 27 has not been pressed, the CPU 106 returns the process flow to step S11. Note that, in case where the start switch 27 has not been pressed (for example, a terminating command of game play has been input without the start switch 27 being pressed), the CPU 106 cancels the subtracting result of the credit amount.

Then, in step S13, if it is determined that the start switch 27 has been pressed, the CPU 106 shifts from step S13 to step S14 and transmits the credit amount had been bet to a payout controller 3. Parallel to this, in step S15, the CPU 106 determines symbols to be stopped. In this stop symbol determination process, the CPU 106 determines symbols to be displayed (rearranged) in the segmented areas q11 to q53 by executing a stop symbol determination program which is one of the game execution programs stored in the ROM 108.

By this stop symbol determination process, each symbol to be rearranged in the segmented areas q11 to q53 shown in FIG. 5 is determined as one of the seven kinds of symbols, “7”, “BAR”, “SUN”, “A (Ace of cards)”, “K (King of cards)”, “Q (Queen of cards)” and “J (Jack of cards)”.

Next, in step S16, the CPU 106 executes symbol changing display process. This process is a process in which symbols are started to be displayed with being changed consecutively in the segmented areas q11 to q53 as shown in FIG. 12 and then the symbols are stopped in the segmented areas q11 to q53 as shown in FIG. 13. By this start and stop process of changing display, symbols are rearranged in the segmented areas q11 to q53.

Upon a termination of the symbol changing display process, the CPU 106 shifts to step S16a and outputs a command to the counter 114 (see FIG. 5) for counting the number of the specific symbols rearranged in the unit games before the special game (step S16a). And then, the number of the specific symbols rearranged in the unit games before the special game is counted by the counter 114.

Upon a termination of the symbol changing display process, parallel to the counting process of the number of specific symbols in the above-mentioned step S16a, the CPU 106 determines whether or not a winning has been brought based on the symbols rearranged in the segmented areas q11 to q53 in step S17. Specifically, the CPU 106 determines whether or not a condition for providing an award has been met.

In this step S17, the CPU 106 determines whether or not the symbol combination rearranged in the above-mentioned step S16 matches with any one of the rearranged symbol modes defined as eligibles for providing a payout in the payout table with reference to the payout table stored in the ROM 108

Then, if it matches with the rearranged symbol mode defined in the payout table, the payout amount corresponding to the rearranged symbol mode is determined as a credit payout for an achievement of a winning and the process flow shifts from step S17 to step S18.

On the other hand, if the symbol combination rearranged in the above-mentioned step S17 does not match with any one of the rearranged symbol modes defined as eligibles for providing a payout in the payout table, the CPU 106 shifts the process to after-mentioned step S19 without an achievement of a winning.

In step S18, the CPU 106 executes a payout process for paying out credits according to a winning result in the above-mentioned step S16. In this payout process, the CPU 106 accumulates the credit payout amount in the above-mentioned step S17 into the credit amount stored in the RAM 111.

In step S19, the CPU 106 executes a sortition to determine whether or not the predetermined condition for a start of free games using a random number generated by the RNG 112. Then, in step S20, the CPU 106 determines whether or not the sortition result indicates an establishment of the predetermined condition.

If the sortition result does not indicate an establishment of the predetermined condition (indicates non-establishment) (NO in step S20), the CPU 106 returns to the above-mentioned step S11 to execute the next slot game processing. If the sortition result indicates an establishment of the predetermined condition (YES in step S20), the CPU 106 executes a special game execution processing in step S21 and then returns to the above-mentioned step S11 to execute the next slot game processing.

Within the special game execution processing of step S21, the CPU 106 executes a normal free game of the special game in step S211 as shown in FIG. 15. The CPU 106 generates the image display command of the normal free game to display the normal free game on the display 16 (step S211).

Subsequently, the CPU 106 determines whether or not a winning has been brought based on the symbols rearranged in the segmented areas q11 to q53 in the normal free game (step S213). In other words the CPU 106 judges whether or not a condition for providing an award has been met.

In this step S213, the CPU 106 determines whether or not the rearranged mode of the symbols rearranged in the segmented areas q11 to q53 matches with any one of rearranged symbol combinations defined as eligibles for providing a payout for a normal free game in the payout table with reference to the payout table stored in a ROM 108.

And then, if it matches with one rearranged symbol combination defined in the payout table (YES in step S213), an award is provided to a player for a winning achievement (step S214).

On the other hand, the above-mentioned symbol combination rearranged in step S211 does not match with any of the rearranged modes defined as the eligibles in the payout table (NO in step S213), the CPU 106 shifts the process flow to step S215 without a winning achievement.

Next, the CPU 106 determines whether or not the number of executed slot games of the normal free games has reached up to the predetermined number of times (step S215).

Then, if the number of executed slot games of the normal free games has not reached up to the predetermined number of times (NO in step S215), the CPU 106 shifts the process flow to step S211. If the number of executed slot games of the normal free games has reached up to the predetermined number of times (YES in step S215), the CPU 106 shifts the process flow to step S216.

Next, the CPU 106 calculates the total number of the specific symbols counted in step S212 during the unit games (slot games) executed before the special game (step S216).

Then, the CPU 106 rearranges trigger symbols to bring an award, the number of which has been increased according to the total number of the specific symbols calculated in step S216, in the special free game executed after the executions of the predetermined number of the normal free games (step S217).

In step S217, the slot machine 10 determines the increase number of trigger symbols to be rearranged in the segmented areas q11 to q53 with reference to the increase number table of trigger symbols (see FIG. 8) stored in the external memory unit 113.

Next, the CPU 106 executes the special free games (step S211). At this time, the CPU 106 generates an image display command, in which the increase number of trigger symbols determined in step S217 is preliminarily rearranged, and then displays the special free game on the display 16.

And then, the CPU 106 determines whether or not a winning has been brought in the special free game base on the symbols rearranged in the segmented area q11 to q53 (step S219). In other words the CPU 106 judges whether or not a condition for providing an award has been met.

In this step S219, the CPU 106 determines whether or not the rearranged mode of the symbols rearranged in the segmented areas q11 to q53 matches with any one of rearranged symbol combinations defined as eligibles for providing an award for a special free game in the payout table with reference to the payout table stored in a ROM 108.

If the symbols rearranged in the segmented areas q11 to q53 have not been brought a result for providing an award to a player (NO in step S219), the CPU 106 terminates the series of processes of the special game.

On the other hand, if the symbols rearranged in the segmented areas q11 to q53 have been brought a result for providing an award to a player (YES in step S219), the CPU 106 provides an award to the player for an award winning (step S220). And then, the CPU 106 executes a payout process for paying out credits corresponding to a payout amount set for an award to be provided. Subsequently, the special game execution processing is terminated.

As described above, in the present embodiment, the CPU 106 constitutes a controller in the claims.

According to the slot machine 10 as configured above, the number of trigger symbols to be rearranged in a special free game is increased according to the total number of specific symbols rearranged in unit games before a special game. Therefore, since the number of trigger symbols to be rearranged in a special free game is expected to be increased as an increase of the number of specific symbols in unit games before a special game, the slot machine 10 in the second embodiment can focus a player's sense of expectancy on a special free game.

In addition, since a sense of expectancy for an increase of trigger symbols is encouraged every rearrangement of specific symbols in unit games before a special game, the slot machine 10 according to the second embodiment can make a player to play games, even if they are unit games before a special game, continuously without boring.

### Third Embodiment

Next, a slot machine 10 and a playing method thereof according to a third embodiment of the present invention will be explained. Since it has substantively the same configuration as those of the slot machine 10 in the first embodiment, redundant explanations will be omitted.

FIG. 1C is a flow chart showing a general scheme of the playing method of the slot machine according to the third embodiment of the present invention.

As shown in FIG. 1C, the slot machine 10 according to the third embodiment of the present invention displays a unit game on the display 16 shown in FIG. 4, in which symbols having been arranged are rearranged (step S1).

Next, as shown in FIG. 1C, the slot machine 10 counts the number of the specific symbols rearranged in the unit games before a special game using the counter 114 (see FIG. 5) (step S2). For example, in case where the specific symbol is a “SUN” symbol and two “SUN” symbols are rearranged on the display 16 as shown in FIG. 6, the counter 114 counts the number of the specific symbols as two.

Next, as shown in FIG. 1C, the slot machine 10 determines whether or not the predetermined condition for a special game execution has been met (step S3). For example, a special game is also called as a free game(s) (feature game(s)), for example. For example, whether or not the predetermined condition has been met can be determined based on whether or not a condition establishment sortition was hit, which is executed based on a random number generated by an RNG 112 shown in FIG. 5 at each of displaying a unit game on the display.

Then, as shown in FIG. 1C, if the predetermined condition has not been met (NO in step S3), the slot machine 10 stops a series of processes and displays a unit game on the display again in step S1.

On the other hand, if the predetermined condition has been met (YES in step S3), the slot machine 10 executes normal free games in a special game (step S4).

The special game is a set of the predetermined number of slot games (e.g. ten games) executed as free games. The special game is composed of normal free games and a special free game. The special free game is a last unit game during the special game. In case where the special game is executed with ten games, the special game may be executed in such a way that nine normal free games are executed and the last one special free game is executed.

Subsequently, the slot machine 10 counts the number of specific symbols had been rearranged in the normal free games using the counter 114 (see FIG. 5) (step S5).

Parallel to the counting process of the number of the specific symbols in the above-mentioned step 5, the slot machine 10 determines whether or not a winning has been achieved according to symbols having been arranged in the segmented areas q11 to q53 (step S6). In other words, the slot machine 10 determines whether or not a condition for providing an award has been met.

In this step S6, the slot machine 10 determines whether or not the rearranged mode of symbols rearranged in the segmented areas q11 to q53 matches with any one of rearranged symbol combinations defined as eligibles for providing a payout in the payout table with reference to the payout table stored in a ROM 108.

Then, if it matches with one rearranged symbol combination defined in the payout table (YES in step S6), an award is provided to a player for a winning achievement (step S7).

On the other hand, the above-mentioned symbol combination rearranged in step S4 does not match with any of the rearranged modes defined as the eligibles in the payout table (NO in step S6), the slot machine 10 shifts the process flow to step S8 without a winning achievement.

Next, the slot machine 10 determines whether or not the number of executed slot games of the normal free games has reached up to the predetermined number of times (nine times in the present embodiment) (step S8).

Then, if the number of executed slot games of the normal free games has not reached up to the predetermined number of times (NO in step S8), the slot machine 10 shifts the process flow to step S4. If the number of executed slot games of the normal free games has reached up to the predetermined number of times (YES in step S8), the slot machine 10 shifts the process flow to step S9.

Next, the slot machine 10 calculates the total number of the specific symbols counted in step S2 during the unit games (slot games) before the special game and the specific symbols counted in step S5 during the normal free games (step S9).

Then, the slot machine 10 rearranges trigger symbols to bring an award, the number of which has been increased according to the total number of the specific symbols calculated in step S9, in the special free game executed after the executions of the predetermined number of the normal free games (step S10).

In step S10, the slot machine 10 determines the increase number of trigger symbols to be rearranged in the segmented areas q11 to q53 with reference to an increase number table of trigger symbols (see FIG. 8) stored in an external memory unit 113.

As a result of the above-mentioned processes, the slot machine 10 according to the third embodiment counts the specific symbols rearranged during unit games before a special game and during normal free games, and can determine to increase the number of trigger symbols in a special free game according to the total number of the counted specific symbols. Therefore, since the number of trigger symbols to be rearranged in a special free game is expected to be increased as an increase of the number of the counted specific symbols, the slot machine 10 in the third embodiment can focus a player's sense of expectancy on a special free game.

In addition, since a sense of expectancy for an increase of trigger symbols is encouraged every rearrangement of specific symbols in unit games before a special game and in normal free games, the slot machine 10 according to the third embodiment can make a player to play games continuously without boring.

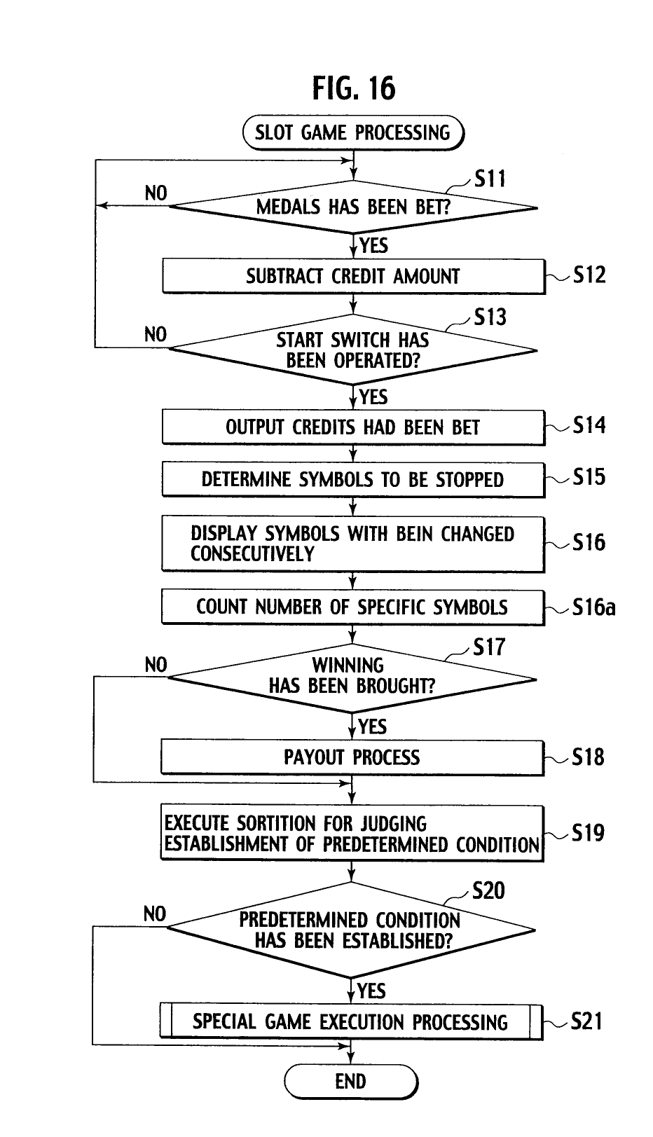

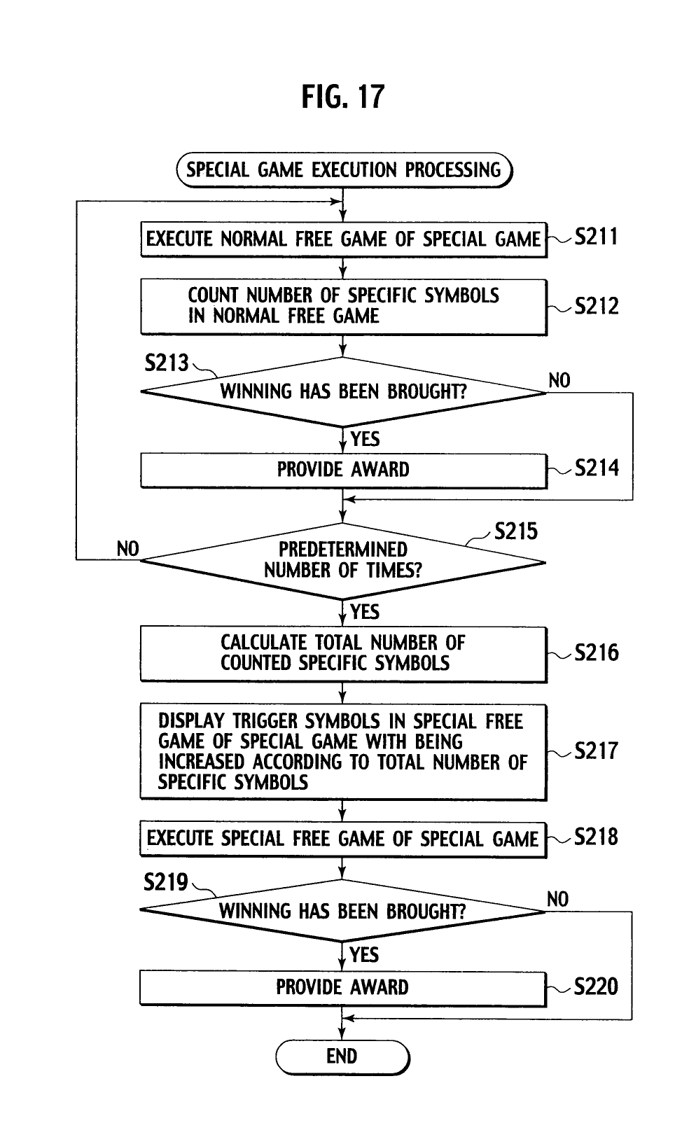

Next, operations of the slot machine 10 in the present embodiment will be explained with reference to flow charts shown in FIGS. 16 and 17. FIGS. 16 and 17 are flow charts showing procedures of the slot game processing and the special game processing executed by the CPU 106 according to the game execution programs stored in the ROM 108.

First, on entering the slot game processing shown in FIG. 16, the CPU 106 determines whether or not credits have been bet in step S11. In this process, the CPU 106 determines whether or not a signal output from the bet switch 25 on the bet switch 25 being pressed or a signal output from the max-bet switch 24 on the max-bet switch 24 being pressed has been received. If it is determined that credits have not been bet, the process flow returned to step S11.

On the other hand, if it is determined that credits have been bet in step S11, the CPU 106 proceeds to step S12 to subtract a credit amount had been bet from credits stored in the RAM 11.

Next, in step S13, the CPU 106 determines whether or not the start switch 27 has been pressed. In this process, the CPU 106 determines whether or not to receive the signal output from the start switch 27 on the start switch 27 being pressed.

If it is determined that the start switch 27 has not been pressed, the CPU 106 returns the process flow to step S11. Note that, in case where the start switch 27 has not been pressed (for example, a terminating command of game play has been input without the start switch 27 being pressed), the CPU 106 cancels the subtracting result of the credit amount.

Then, in step S13, if it is determined that the start switch 27 has been pressed, the CPU 106 shifts from step S13 to step S14 and transmits the credit amount had been bet to a payout controller 3. Parallel to this, in step S15, the CPU 106 determines symbols to be stopped. In this stop symbol determination process, the CPU 106 determines symbols to be displayed (rearranged) in the segmented areas q11 to q53 by executing a stop symbol determination program which is one of the game execution programs stored in the ROM 108.

By this stop symbol determination process, each symbol to be rearranged in the segmented areas q11 to q53 on the first to fifth columns shown in FIG. 3 is determined as one of the seven kinds of symbols, “7”, “BAR”, “SUN”, “A (Ace of cards)”, “K (King of cards)”, “Q (Queen of cards)” and “J (Jack of cards)” shown in FIG. 7.

Next, in step S16, the CPU 106 executes symbol changing display process. This process is a process in which symbols are started to be displayed with being changed consecutively in the segmented areas q11 to q53 as shown in FIG. 12 and then the symbols are stopped in the segmented areas q11 to q53 as shown in FIG. 13. By this start and stop process of changing display, symbols are rearranged in the segmented areas q11 to q53.

Upon a termination of the symbol changing display process, the CPU 106 shifts to step S16a and outputs a command to the counter 114 (see FIG. 5) for counting the number of the specific symbols rearranged in the unit games before the special game (step S16a). And then, the number of the specific symbols rearranged in the unit games before the special game is counted by the counter 114.

Upon a termination of the symbol changing display process, parallel to the counting process of the number of specific symbols in the above-mentioned step S16a, the CPU 106 determines whether or not a winning has been brought based on the symbols rearranged in the segmented areas q11 to q53 in step S17. Specifically, the CPU 106 determines whether or not a condition for providing an award has been met.

In this step S17, the CPU 106 determines whether or not the symbol combination rearranged in the above-mentioned step S16 matches with any one of the rearranged symbol modes defined as eligibles for providing a payout in the payout table with reference to the payout table stored in the ROM 108

Then, if it matches with the rearranged symbol mode defined in the payout table, the payout amount corresponding to the rearranged symbol mode is determined as a credit payout for an achievement of a winning and the process flow shifts from step S17 to step S18.

On the other hand, if the symbol combination rearranged in the above-mentioned step S17 does not match with any one of the rearranged symbol modes defined as eligibles for providing a payout in the payout table, the CPU 106 shifts the process to after-mentioned step S19 without an achievement of a winning.

In step S18, the CPU 106 executes a payout process for paying out credits according to a winning result in the above-mentioned step S16. In this payout process, the CPU 106 accumulates the credit payout amount in the above-mentioned step S17 into the credit amount stored in the RAM 111.

In step S19, the CPU 106 executes a sortition to determine whether or not the predetermined condition for a start of free games using a random number generated by the RNG 112. Then, in step S20, the CPU 106 determines whether or not the sortition result indicates an establishment of the predetermined condition.

If the sortition result does not indicate an establishment of the predetermined condition (indicates non-establishment) (NO in step S20), the CPU 106 returns to the above-mentioned step S11 to execute the next slot game processing. If the sortition result indicates an establishment of the predetermined condition (YES in step S20), the CPU 106 executes a special game execution processing in step S21 and then returns to the above-mentioned step S11 to execute the next slot game processing.

Within the special game execution processing of step S21, the CPU 106 executes a normal free game of the special game in step S211 as shown in FIG. 15. The CPU 106 generates the image display command of the normal free game to display the normal free game on the display 16 (step S211).

Subsequently, the CPU 106 output a command to the counter 114 (see FIG. 5) for counting the number of the specific symbols rearranged in the normal free games (step S212). And then, the number of specific symbols in the normal free games is counted by the counter 114.

Parallel to the counting process of the number of specific symbols in the above-mentioned step S212, the CPU 106 determines whether or not a winning has been brought based on the symbols rearranged in the segmented areas q11 to q53 in the normal free game (step S213). In other words the CPU 106 judges whether or not a condition for providing an award has been met.

In this step S213, the CPU 106 determines whether or not the rearranged mode of the symbols rearranged in the segmented areas q11 to q53 matches with any one of rearranged symbol combinations defined as eligibles for providing a payout for a normal free game in the payout table with reference to the payout table stored in a ROM 108.

And then, if it matches with one rearranged symbol combination defined in the payout table (YES in step S213), an award is provided to a player for a winning achievement (step S214).

On the other hand, the above-mentioned symbol combination rearranged in step S211 does not match with any of the rearranged modes defined as the eligibles in the payout table (NO in step S213), the CPU 106 shifts the process flow to step S215 without a winning achievement.

Next, the CPU 106 determines whether or not the number of executed slot games of the normal free games has reached up to the predetermined number of times (step S215).

Then, if the number of executed slot games of the normal free games has not reached up to the predetermined number of times (NO in step S215), the CPU 106 shifts the process flow to step S211. If the number of executed slot games of the normal free games has reached up to the predetermined number of times (YES in step S215), the CPU 106 shifts the process flow to step S216.

Next, the CPU 106 calculates the total number of the specific symbols counted during the unit games (slot games) before the special game and the specific symbols counted in step S212 during the normal free games (step S216).

Then, the CPU 106 rearranges trigger symbols to bring an award, the number of which has been increased according to the total number of the specific symbols calculated in step S216, in the special free game executed after the executions of the predetermined number of the normal free games (step S217).

In step S217, the slot machine 10 determines the increase number of trigger symbols to be rearranged in the segmented areas q11 to q53 with reference to the increase number table of trigger symbols (see FIG. 8) stored in the external memory unit 113.

Next, the CPU 106 executes the special free games (step S218). At this time, the CPU 106 generates an image display command, in which the increase number of trigger symbols determined in step S217 is preliminarily rearranged, and then displays the special free game on the display 16.

And then, the CPU 106 determines whether or not a winning has been brought in the special free game base on the symbols rearranged in the segmented area q11 to q53 (step S219). In other words the CPU 106 judges whether or not a condition for providing an award has been met.

In this step S219, the CPU 106 determines whether or not the rearranged mode of the symbols rearranged in the segmented areas q11 to q53 matches with any one of rearranged symbol combinations defined as eligibles for providing an award for a special free game in the payout table with reference to the payout table stored in a ROM 108.

If the symbols rearranged in the segmented areas q11 to q53 have not been brought a result for providing an award to a player (NO in step S219), the CPU 106 terminates the series of processes of the special game.

On the other hand, if the symbols rearranged in the segmented areas q11 to q53 have been brought a result for providing an award to a player (YES in step S219), the CPU 106 provides an award to the player for an award winning (step S220). And then, the CPU 106 executes a payout process for paying out credits corresponding to a payout amount set for an award to be provided. Subsequently, the special game execution processing is terminated.

As described above, in the present embodiment, the CPU 106 constitutes a controller in the claims.

According to the slot machine 10 as configured above, the number of trigger symbols to be rearranged in a special free game is increased according to the total number of specific symbols rearranged in unit games before a special game and normal free games. Therefore, since the number of trigger symbols to be rearranged in a special free game is expected to be increased as an increase of the number of specific symbols in unit games before a special game and normal free games, the slot machine 10 in the third embodiment can focus a player's sense of expectancy on a special free game.

In addition, since a sense of expectancy for an increase of trigger symbols is encouraged every rearrangement of specific symbols in unit games before a special game and normal free games, the slot machine 10 according to the third embodiment can make a player to play games, even if they are unit games before a special game or normal free games, continuously without boring.

### Other Embodiments

Although embodiments of the present invention have been described as above, they are only presented as concrete examples, without particularly limiting the present invention. Concrete arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

For example, although the slot machine 10 in the first to third embodiments determines an award to be provided to a played according to the number of the trigger symbols rearranged in the segmented areas q11 to q53, it maybe determined according to the number of the trigger symbols rearranged along an activated line(s) set on the segmented areas q11 to q53.

In addition, although a specific symbol and a trigger symbol are differentiated each other in the slot machine 10 in the first to third embodiments, they may be identical by regarding a trigger symbol as a specific symbol. For example, if a trigger symbol is “7”, a specific symbol can be also “7”.

In addition, although an image display command, in which the increase number of trigger symbols determined in step S217 is preliminarily rearranged, is generated in the first embodiment, the trigger symbols may not be preliminarily rearranged. Since the special free game should bring the rearranged mode with the increased trigger symbols as its result, the slot machine 10 can generates an image display command by adding the trigger symbols onto reel images to display symbols with being changed consecutively in the segmented areas q11 to q53.

In addition, although the predetermined number of games within the special game is set to ten in the slot machine 10 in the first to third embodiments, it may not be limited to ten.

In the above detailed description, mainly characteristic portions have been set forth so that the present invention can be understood more easily. The present invention is not limited to the embodiments set forth in the above detailed description and can be applied to other embodiments, with a wide range of applications. In addition, terms and wordings used in the present specification are used to precisely explain the present invention and are not intended to limit the interpretation of the present invention. Also, those skilled in the art will easily conceive, from the concept of the invention set forth in the present specification, other arrangements, systems or methods included in the concept of the present invention. Therefore, it should be appreciated that the scope of the claims includes equivalent arrangements without deviating from the scope of technical ideas of the present invention. In addition, the purpose of the abstract is to facilitate the Patent Office and general public institutions, or engineers in the technological field who are not familiar with patent and legal terms or specific terms to quickly evaluate technical contents and the essence of this application by simple investigation. Therefore, the abstract is not intended to limit the scope of the invention, which should be evaluated by descriptions of the scope of the claims. Furthermore, it is desirable to take into consideration the already disclosed literatures sufficiently in order to completely understand the objects and specific effects of the present invention.

The above detailed description includes processes executed by a computer. The aforementioned descriptions and expressions are described with a purpose that those skilled in the art will understand them most efficiently. In the present specification, each step used for deriving one result should be understood as a self-consistent process. Also, transmission, reception and recording of electric or magnetic signals are executed in each step. In the processes in respective steps, although such signals are expressed as bits, values, symbols, characters, terms or numerals, it should be noted that these are merely used for convenience of explanation. Additionally, although the processes in respective steps may be described using an expression common to human activities, the processes described in the present specification are executed, in principle, by a variety of devices. Furthermore, other arrangements required to execute respective steps are self-evident from the aforementioned description.

What is claimed is:

1. A slot machine comprising:
a display for displaying a unit game in which symbols having been arranged are rearranged in segmented areas and displaying, upon establishment of a predetermined condition, a special game including normal free games and a special free game;
a counter for counting the number of specific symbols rearranged in the segmented areas; and
a controller programmed to execute following (A) to (D)
(A) a process for determining whether or not to provide an award to a player according to a rearranged mode of trigger symbols rearranged in the special game,
(B) a process for counting the number of specific symbols during a predetermined number of normal free games in case where one or more specific symbols are included in symbols rearranged in the segmented areas,
(C) a process for calculating the total number of counted specific symbols before an execution of the special free game that is executed after the normal free games, and
(D) a process for increasing the number of trigger symbols to be rearranged in the special free game according to the total number of counted specific symbols.

2. The slot machine according to claim 1, wherein
the controller executes a process for determining an award pattern according to the number of rearranged trigger symbols in case where a plurality of award patterns to be provided to a player is prepared.

3. The slot machine according to claim 1, wherein
the controller executes a process for determining an award pattern according to the number of trigger symbols rearranged along an activated line in case where a plurality of award patterns to be provided to a player is prepared.

4. The slot machine according to claim 1, wherein
the specific symbol is the trigger symbol.

5. A slot machine comprising:
a display for displaying a unit game in which symbols having been arranged are rearranged in segmented areas and displaying, upon establishment of a predetermined condition, a special game including normal free games and a special free game;
a counter for counting the number of specific symbols rearranged in the segmented areas; and
a controller programmed to execute following (A) to (D)
(A) a process for determining whether or not to provide an award to a player according to a rearranged mode of trigger symbols rearranged in the special game,
(B) a process for counting the number of specific symbols during unit games before the special game in case where one or more specific symbols are included in symbols rearranged in the segmented areas,
(C) a process for calculating the total number of counted specific symbols before an execution of the special free game that is executed after the normal free games, and
(D) a process for increasing the number of trigger symbols to be rearranged in the special free game according to the total number of counted specific symbols.

6. The slot machine according to claim 5, wherein
the controller executes a process for determining an award pattern according to the number of rearranged trigger symbols in case where a plurality of award patterns to be provided to a player is prepared.

7. The slot machine according to claim 6, wherein
the controller executes a process for determining an award pattern according to the number of trigger symbols rearranged along an activated line in case where a plurality of award patterns to be provided to a player is prepared.

8. A slot machine comprising:
a display for displaying a unit game in which symbols having been arranged are rearranged in segmented areas and displaying, upon establishment of a predetermined condition, special game including normal free games and a special free game;
a counter for counting the number of specific symbols rearranged in the segmented areas; and
a controller programmed to execute following (A) to (D)
(A) a process for determining whether or not to provide an award to a player according to a rearranged mode of trigger symbols rearranged in the special game,
(B) a process for counting the number of specific symbols during unit games before the special game and a predetermined number of normal free games in case where one or more specific symbols are included in symbols rearranged in the segmented areas,
(C) a process for calculating the total number of counted specific symbols before an execution of the special free game that is executed after the normal free games, and
(D) a process for increasing the number of trigger symbols to be rearranged in the special free game according to the total number of counted specific symbols.

9. The slot machine according to claim 8, wherein
the controller executes a process for determining an award pattern according to the number of rearranged trigger symbols in case where a plurality of award patterns to be provided to a player is prepared.

10. The slot machine according to claim 8, wherein
the controller executes a process for determining an award pattern according to the number of trigger symbols rearranged along an activated line in case where a plurality of award patterns to be provided to a player is prepared.

11. A control method of a slot machine that includes a display for displaying a unit game in which symbols having been arranged are rearranged in segmented areas and displaying, upon establishment of a predetermined condition, a special game including normal free games and a special free game, and a counter for counting the number of specific symbols rearranged in the segmented areas, the method comprising:
executing a process for determining whether or not to provide an award to a player according to a rearranged mode of trigger symbols rearranged in the special game;
executing a process for counting the number of specific symbols by the counter during a predetermined number of normal free games in case where one or more specific symbols are included in symbols rearranged in the segmented areas;
executing a process for calculating the total number of counted specific symbols before an execution of the special free game that is executed after the normal free games; and
executing a process for increasing the number of trigger symbols to be rearranged in the special free game according to the total number of counted specific symbols.

12. The control method of a slot machine according to claim 11, further comprising:
executing a process for determining an award pattern according to the number of rearranged trigger symbols in case where a plurality of award patterns to be provided to a player is prepared.

13. The control method of a slot machine according to claim 11, further comprising:
executing a process for determining an award pattern according to the number of trigger symbols rearranged along an activated line in case where a plurality of award patterns to be provided to a player is prepared.

14. The control method of a slot machine according to claim 11, wherein
the specific symbol is the trigger symbol.
